(19) United States
(12) Patent Application Publication
(10) Pub. No.: US 2014/0297535 A1
(43) Pub. Date: Oct. 2, 2014

(54) System and Method for Compliant Integrated Workflow

(71) Applicant: Docupace Technologies, Inc., Los Angeles, CA (US)

(72) Inventors: Michael PINSKER, Los Angeles, CA (US); Tom EMBROGNO, Henderson, NV (US)

(73) Assignee: Docupace Technologies, Inc., Los Angeles, CA (US)

(21) Appl. No.: 14/223,718

(22) Filed: Mar. 24, 2014

Related U.S. Application Data
(63) Continuation-in-part of application No. 13/093,845, filed on Apr. 26, 2011.

(51) Int. Cl. G06Q 10/10; G06Q 20/04

(52) U.S. Cl. CPC G06Q 10/10; G06Q 20/042
USPC 705/45; 705/342

(57) ABSTRACT

One or more embodiments of the invention allows a customer to use a uniform graphical user interface instead of multiple, discrete processing software applications and discrete hardware peripherals with different graphical user interfaces to enter data, perform workflow processing, validate the data entered and guide the customer with instructions. One or more embodiments of the invention simplifies the transfer of data between different applications/systems which are used in a workflow process, simplifies the entry of data by reducing or eliminating the need to reenter the same data, provides validation of the data entered by the customer and guides the customer with instructions. The data may also be transferred from one discrete hardware peripheral to another peripheral or a third party software application and increases customer ease by presenting the user with a uniform graphical user interface.

### CROSS-REFERENCE TO RELATED APPLICATIONS

The present application is a continuation in part of U.S. patent application Ser. No. 13/093,845, filed on Apr. 25, 2011, which is herein incorporated by reference for completeness of disclosure.

### BACKGROUND OF THE INVENTION

1. Field of the Invention

Embodiments of the invention described herein pertain to the field of digital workflow systems. More particularly, but not by way of limitation, one or more embodiments of the invention enable a system and method of uniform integrated workflow.

2. Description of the Related Art

The current systems for document processing for financial service providers are a collection of discrete components such as discrete form providers, e-signature processing providers, signature pads, document scanning, and check scanning providers. These discrete components often have discrete user interfaces which are difficult to interface with other components or require manual intervention and additional processing steps to transfer data from one component to another. These different components require the customer to process the documents in discrete steps which involves a lot of manual processing steps such as retrieving a form manually and saving the form manually, filling the form manually using a different software, printing the form using different printer interfaces, scanning the form and scanning a check using the native scanner software interface. Some or all of these steps involve discrete peripherals with their own manufacturer specific designs and often incompatible and separate user interface elements or software for operating these specific devices. Once a processing step is complete, it is often necessary to save the intermediate files and reopen these files in a new software. Alternatively, the physical forms after they are filled in may then be mailed to the back-office of the service provider for verification and validation of all information. This results in a lot of paperwork which has to be shipped between offices and consequent delay in processing while the paperwork is in transit to just verify all the necessary paperwork is available. Any errors in the application form may be identified only at the back-office level and may not be apparent when they are filled in. This could lead to further delays in processing. The application processing and acceptance delay may also result in delayed payment of commissions to the customers or financial advisors. Even when these forms are scanned and mailed the data is often processed at the back-end.

On the other end of the spectrum are proprietary solutions provided by service providers which are integrated tightly into their network. These systems lock the customers to one single service provider. The customers who want to provide services from multiple service providers need multiple proprietary systems which increase the complexity and size of operation of the customers. These systems often have their own peculiar interfaces which require special training.

If a customer moves from one service provider to another, entire systems and processes have to be changed. When customers move from one service provider to another, financial regulation rules may prevent the customer from receiving actuarial data and other proprietary information until the notice period required by the financial regulators has passed. This may result in an expensive transition and at times aborted transition between service providers. The service providers may lose out on incentives they provided to the customers. There may also be a delay in procuring new customers due to the delay in sharing proprietary information or information barred by financial service regulations.

To overcome the problems and limitations described above there is a need for a system and method which provides a uniform interface to the customer which integrates discrete interface elements, discrete peripherals and integrates the entire workflow irrespective of the product and differences in the internal workflow.

### BRIEF SUMMARY OF THE INVENTION

One or more embodiments of the invention allows a customer to use a uniform graphical user interface instead of multiple, discrete processing software applications and discrete hardware peripherals with different graphical user interfaces to enter data, perform workflow processing, validate the data entered and guide the customer with instructions. The invention simplifies the transfer of data between different applications/systems which are used in a workflow process, simplifies the entry of data by reducing or eliminating the need to reenter the same data, provides validation of the data entered by the customer and guides the customer with instructions. The data may also be transferred from one discrete hardware peripheral to another peripheral or a third party software application and increases customer ease by presenting the user with a uniform graphical user interface. The invention also allows the user to use the uniform graphical user interface irrespective of the differences in construction of forms between the different service providers. The invention also abstracts the customer from the differences and allows the user to focus on the data instead of the layout of the form and differences between service providers or differences in form layout of different products. One or more embodiments of the invention also allows the customer to use the uniform user interface to perform straight through processing by integrating check processing including check fraud processing, e.g., check 21 processing, processing of multiple forms, electronic signatures, document management and work-flow processing. One or more embodiments of the invention may also enable multiple validations at different stages of processing to ensure the information is sufficient and is accurate and complies with financial regulations and the standards of service providers upfront instead of at the backend when it is being processed. The upfront validation and/or validation at different stages reduces the time required for document processing, increases compliance and easier audits and reduces turnaround time and costs.

The current invention may be directed to a set of instructions on a computer memory which may be run on computers with one or more processors. The instructions may allow the customer to select at least one or more products using a uniform user interface displayed on a computer terminal. The instructions may then allow the computer to select at least one form from a form provider library based on the product selection of the customer. The instructions may also be tailored to select the appropriate form from the form library based on the service provider information selected by the customer using the said uniform user interface.

The instructions may also provide for the customer to fill the form selected from a form library with information obtained from the customer. The customer in this system may be a financial advisor who obtains such data from a client. The client in this invention is referred to as consumer. This data obtained from the customer may be at least one of form data, signature data, and signature pads and scanned documents, which may be obtained from the customer using a uniform user interface. For example, signature pads may be a touch sensitive computer interface such as a tablet, or a specialized hardware used for capturing signature information. For example, signature data may be electronic signature data such as an encryption key provided by a electronic key provider based on public key cryptography which verifies the identity of the entity in question. In one or more embodiments form data could be electronic form data. All data obtained from the customer may be validated using at least one criteria wherein the criteria is at least one of a business logic set by business analyst using a meta-language, form sufficiency information, optional information sufficiency, transformational validation, electronic signature verification, physical signature capture, transformational validation and document scanning. Once all the information has been received from the client the data may be transformed into a document package consistent with the low level application programming interfaces (“API”) which is an interface used by service providers for exchange of information from third parties into their computer system. In one or more embodiments of the invention, the uniform graphical user interface may be used to display information which has already been transmitted to the service provider, either by retrieving the document package from the service provider or by storing the document package in a server after processing the document package.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a general-purpose computer and peripherals that when programmed as described herein may operate as a specially programmed computer capable of implementing one or more methods, apparatus and/or systems of the solution.

FIG. 2 illustrates a system diagram in accordance with one or more embodiments of the present invention.

FIG. 3 illustrates an exemplary flowchart for the product workflow in accordance with one or more embodiments of the present invention.

FIG. 4 illustrates a high level overview system diagram in accordance with one or more embodiments of the present invention.

FIG. 5 illustrates an exemplary flowchart for the new account workflow process in accordance with one or more embodiments of the present invention.

FIG. 6 illustrates an exemplary flowchart for the advertisement review workflow process in accordance with one or more embodiments of the present invention.

FIGS. 7A and 7B illustrate exemplary flowcharts for the representative on boarding and licensing and registration workflow process in accordance with one or more embodiments of the present invention.

FIG. 8 illustrates an exemplary flowchart for the deposits, cashiering and commissions workflow process in accordance with one or more embodiments of the present invention.

FIG. 9 illustrates an exemplary flowchart for the direct business process in accordance with one or more embodiments of the present invention.

FIG. 10 illustrates an exemplary flowchart for the central oversight and audit, alerts and escalation and workflow monitoring process in accordance with one or more embodiments of the present invention.

FIG. 11 illustrates an exemplary flowchart for the transfer/transition workflow in accordance with one or more embodiments of the present invention.

### DETAILED DESCRIPTION

In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

The term “module”, “Software Application” may refer to either a stand-alone software application or a module of a Software Application, which provides a functionality. The modules and their functions could be provided as services. The term “customer”, “user” may be used interchangeably.

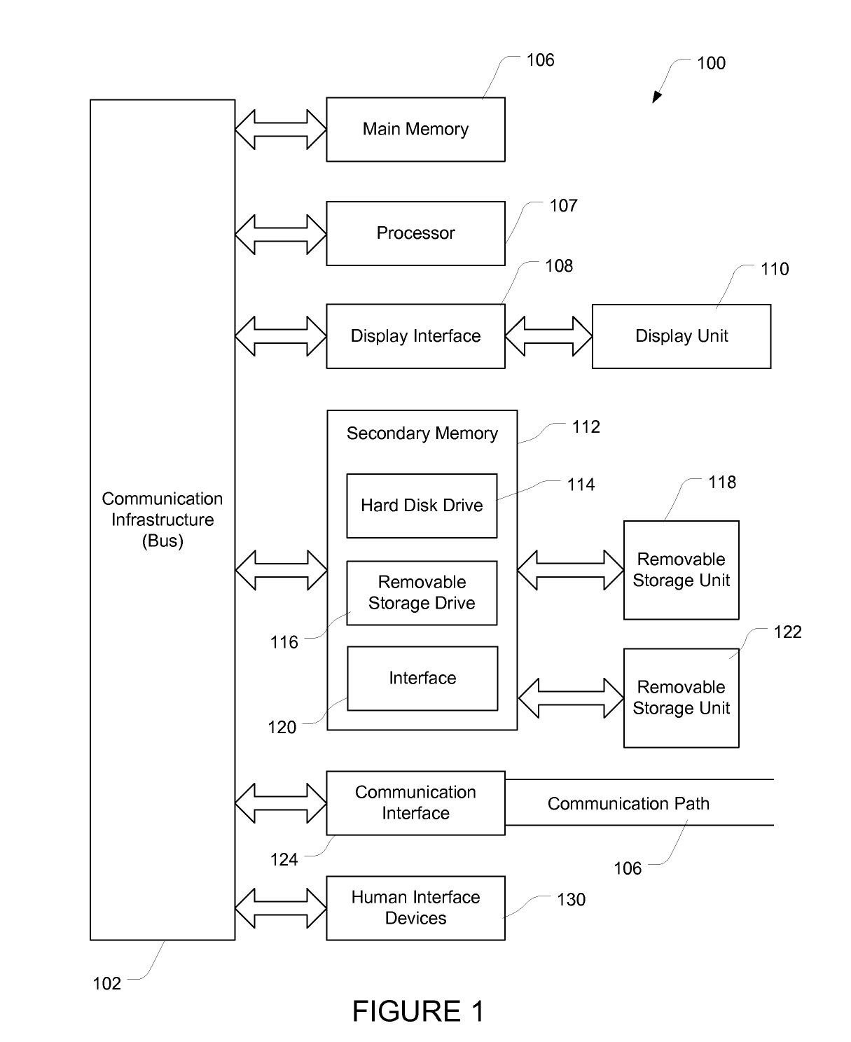

FIG. 1 diagrams a general-purpose computer and peripherals, when programmed as described herein, may operate as a specially programmed computer capable of implementing one or more methods, apparatus and/or systems of the solution described in this disclosure. Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may comprise one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may comprise, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also comprise interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 126 may comprise any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 1.

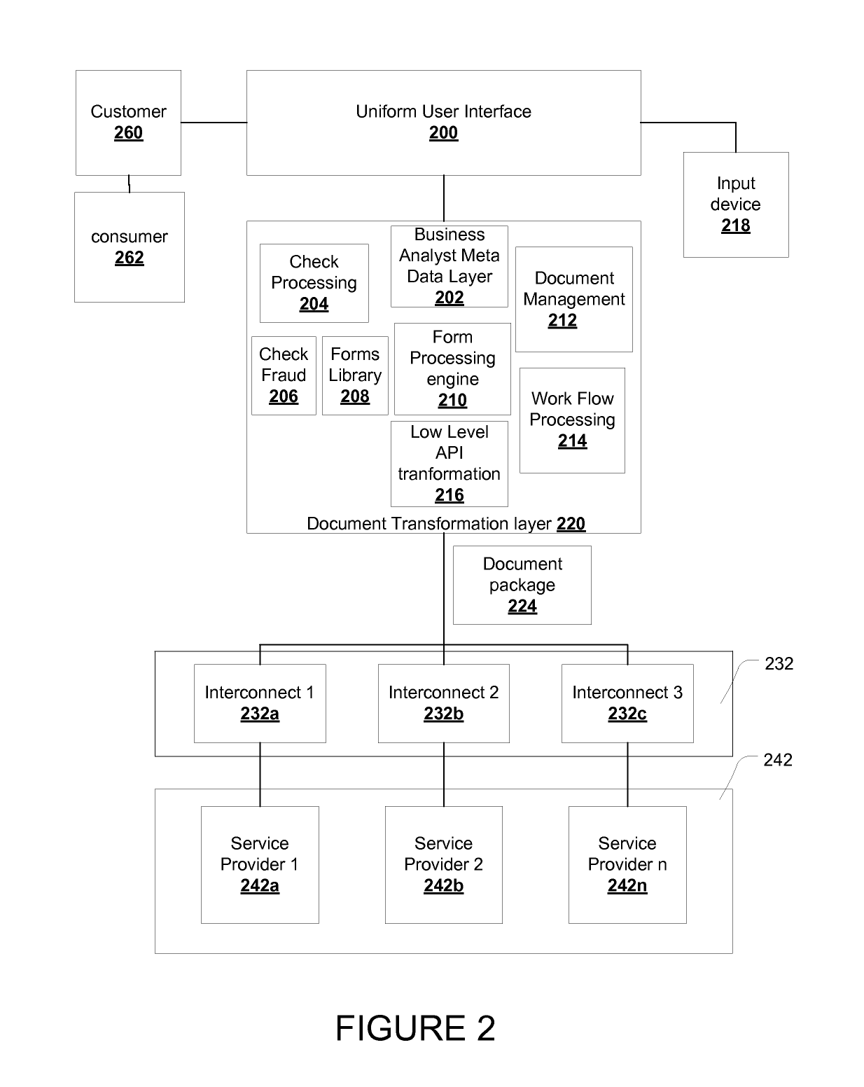

FIG. 2 illustrates an exemplary system diagram in accordance with one or more embodiments of system and methods for uniform integrated workflow.

Uniform integrated workflow system comprises of a uniform user interface 200 configured to capture and validate the information upfront and to provide prompts for missing data. The uniform user interface 200 encapsulates the different interfaces of subsystems which may be provided by third parties and provides a single interface for entry and collection of all information necessary for a transaction. The uniform user interface 200 enables transaction with disparate systems without duplication by reusing data entered by a customer 260 once, when such data entry is required at multiple places in the same form, when more than one form is required for a particular product of a service provider, e.g. 242a, when such data entry is required when accessing products of different service providers, e.g. 242a and 242b, and/or when such data entry is required when transferring a Consumer 262 between service providers, e.g. 242a and 242b. For example a consumer 262 may be an The uniform user interface 200 abstracts the data elements present in a number of forms, sufficiency requirements and additional documentation requirements with the same service provider 242 or available across multiple service providers 242a, 242b through 242n. For example, a 401k plan from multiple providers, e.g. 242a, 242b and 242n, may have substantially the same information required from customer 260. For example, customer 260 may need to provide name, social security number, beneficiary and type of investment plan to be used. A uniform user interface 200 can easily cater to the same 401k plan from multiple service providers and make the interaction with the system simpler for the customer 260. A uniform user interface 200 may, for example, provide for validation by checking for presence or absence of data, computational validation of data, sufficiency validation of data to meet the minimum requirements and informational validation by prompting the customer 260 with a rule on the data required. For example, a customer 260 may be prompted to ensure the date entered is in the MM/DD/YYYY format to prevent mix up of months and days. In a computational validation, the information may be validated by processing the data entered by a customer to obtain a derivative data to validate if the data entered is accurate. For example, margin brokerage accounts may require a minimum balance to be maintained with a broker before transactions are allowed, and the margin requirements may be satisfied by stocks of sufficient value which are in an account of a consumer. This data may be computationally validated before accepting a new account application or a transaction from the consumer. A uniform user interface 200 may integrate multiple types of input device 218 such as a keyboard, mouse, forms database, signature processing, signature pads, document and check scanning hardware etc. around a uniform user interface 200 instead of multiple discrete interfaces for each workflow process.

The back end system powering the uniform user interface is the document transformation layer 220. The document transformation layer 220 includes a business analyst metadata layer 202. The business analyst metadata layer 202 may be implemented using meta-language which is easier to program in and can be changed based on the changes in business environment or in legal environment. For example, a change in the business environment could be a new business risk and a procedural requirement for reducing the risk may make some data, which was originally optional, now necessary for processing. For example, a change in legal environment may be a new legislation or new regulatory requirement which requires changes to the workflow process or processing of forms or content of forms. The business analyst metadata layer 202 may be provided by multiple third parties. The business analyst metadata layer 202 may be tailored to a service provider, e.g. 242a, or type of plan. The business analyst metadata layer 202 may also be implemented as a matrix which maps form regions to corresponding rules and validation requirements. In such embodiments, a business analyst is able to enter or update information, business logic or rule set. For example, a 401k plan might have the business analyst metadata layer 202 which shares a number of features across different service providers.

The business analyst meta-data layer 202 in turn uses a number of modules which includes check processing module 204, check fraud module 206, forms library 208, form processing engine 210, document management 212, and workflow processing 214. One or more of these modules may be created, made available or provided either as a software module or a service by a third party. For example, a third party may provide the check processing module 204, a different third party may provide the check fraud module 206, and yet another third party may provide the forms library 208. A transaction in the system may involve one or more of these modules. Each of these modules may interface with specialized or general purpose input hardware. The uniform user interface 200 encapsulates the interface which provides for a consistent look and feel without the need for the customer 260 to use multiple inconsistent user interfaces and multiple inconsistent interfaces of devices like a scanner which may output an image file which then needs to be processed or added to a different software application to complete a transaction. There is seamless access to information, both electronic and non-electronic. Seamless access to information in non-electronic format may be made available through, document scanners, finger print scanners, touch sensitive interface, electronic signature pads and such other interfaces. The data captured may then be validated by one or more of the modules such as a check fraud module 206. In one or more embodiments check fraud module 206 the check fraud detection may be Check 21 processing.

The forms library 208 may have a collection of forms for each service provider, e.g. 242a, 242b through 242n. These forms may contain essential fields, optional fields and additional material which needs to be filed based on the transaction. Each form may be unique to a service provider, e.g. 242a. A few of the examples of forms includes but is not limited to 401k, 403b, 529 plans, IRA's etc. These forms may have the fields linked to business logic in the matrix implementation as set forth hereinabove or using meta-language in the Business Analyst Metadata Layer 202. The business logic may dictate which combination of forms, essential fields, optional fields and additional material is required for each transaction. The forms library 208 may be updated as and when the service provider updates the forms.

The form processing engine 210 links the business analyst metadata layer 202 instructions and transforms the lower-level API transformation layer 216. The form processing engine 210 ensures the sufficiency of the data, handles the validations of the form data based on business analyst metadata which consists of rules and business logic. The forms processing engine 210 might use a number of validations. The validation used in this case could be one of presence or absence of a data, such as a form field, electronic signature, electronic form, document etc. The validation may be validation used to identify information which is optional but is recommended. The validation may be informational messages which help with filing out the form based on prior selections. The validation may be transformational validation which confirms whether the data entered is consistent with the requirements or verify if the data is real. The transformation validation may also check if a particular data is in the right form and has the right meaning. For example, the validation may check if the entered details are accurate for the first name and surname. The validation may determine whether the form selected from forms library 208 is the right form or whether all the necessary forms are selected if there are multiple forms. Based on the results of the business logic analysis, the customer 260 may be requested to provide additional inputs. The document management module 212 may permit the retrieval, storage and transmission of forms, signatures and other information required for a workflow process.

A workflow processing module 214 may enable different workflows such as new accounts, deposits, cashiering, licensing, commissions, advertising revenue, direct business, representative on boarding, transitions/transfers, central oversight/audit, alerts and escalations and workflow monitoring. The workflow processing module 214 may then transform the input provided by the customer 260 to perform further validation or provide additional assistance to the customer 260 to fill in the right kind of information necessary for processing through validation in conjunction with the form processing engine 210 and other modules.

A low level API transformation layer 216 transforms the captured data into document packages which are acceptable to interconnect 232 (collectively 232 and individually 232a, 232b through 232n) mechanism of a service provider, e.g. 242a. The interconnect mechanism of a service provider 242 may expect the document package in a particular format. The low level API transformation layer 216 encloses a document package 224 with sufficient information enclosed in the application as validated by the business analyst meta-metadata layer 202 to prevent any missing or invalid data being transmitted to the service provider 242. The data package 224 may consist of forms, the data necessary for the forms, optional additional form information, electronic check information and other scanned documents such as id cards, verification codes etc. In one or more embodiments the document management module 212 described hereinabove may store the document package 224 transmitted to the service provider for later retrieval and display by customer 260 or for direct access to consumer 262 of customer. The document management module 212 may also allow this information to permit the customer to retrieve the information from earlier document packages and reuse the data for a different product.

In one or more embodiments, Check processing module 204 and Check fraud module 206 may use an input device 218, e.g., Magnetic Ink Character Recognition scanner that reads the magnetic ink and written information off the check. The image, front and back, of the check and data elements such as account number, name, date, routing number, name of payee, endorsements etc., are passed to the document transformation layer 220. In one or more embodiments, the paper check is voided and either given back to the consumer, e.g., investor or shredded. The image of the check and data are linked with the associated application and an instruction letter is generated and placed on a holding queue until the electronic documents are signed by all parties and evidenced for supervision. Once the document package 224 is ready to be electronically transmitted to the clearing house or product carrier, the instruction letter is released so that the application, data, and funds all arrive at the correct service provider, e.g. 242a proper location and arrives intact. In accordance with compliance requirements, the custody of the check is logged and a check blotter is automatically created and stored.

The document transformation layer 220 and uniform user interface 200 is independent of the service provider 242. The document transformation layer 220 packs in the business logic using the Business Analyst Metadata 202 which allows for the shielding of business logic and data from customers 260 when necessary. For example, while transitioning a broker from one service provider, e.g. 242a, to another. Regulatory requirements or the business requirements of a financial institution might prevent the sharing of actuarial information for insurance purposes or certain best practices or packages with the customer 260. This in turn delays the transitioning or may derail the transitioning. The regulatory process may involve new paperwork for transitioning consumers 262 from one service provider 242a to another service provider 242b. Embodiments of the invention enable a much more seamless transition with all the information captured upfront and transmitted to the service provider 242.

Similarly, the same system allows for a customer 260 to utilize the same system to provide services for more than one service provider, e.g. 242a, 242b, 242n. This allows the customer 260 to seamlessly provide services or choose multiple products from multiple service providers, e.g. 242a, 242b. In practice, a service provider, e.g. 242a, usually provides locked in modules where all of the system is proprietary and this prevents the customer 260 from using a different service provider, e.g. 242b. Also, current systems may require the customer 260 to use more than one document processing system to provide services from multiple service providers. This is not helpful to the customer 260 nor is it beneficial to the service providers 242. Although conventional wisdom suggests that service providers benefit due to lockdowns, the uniform system described herein allows the service provider 242 to access new customers 260 who may otherwise be locked into a different service provider 242. This is also beneficial to the customers 260 as they can expand their business by offering multiple products without additional overhead and additional incompatible separate systems or an office with discrete systems.

One or more consumers 262 may be connected to the customer 260 and may be provided direct access to the products of the service provider 242 through a direct access system to enable the consumers 262 to access products more readily without visiting a customer 260 location. This also enables the customer 260 to expand their business without too much overhead. The consumer 262 making errors or not providing enough information is avoided due to the business logic rules embedded in the Business Analyst Metadata layer 202. This enables more confidence in opening up complex forms for consumer 262.

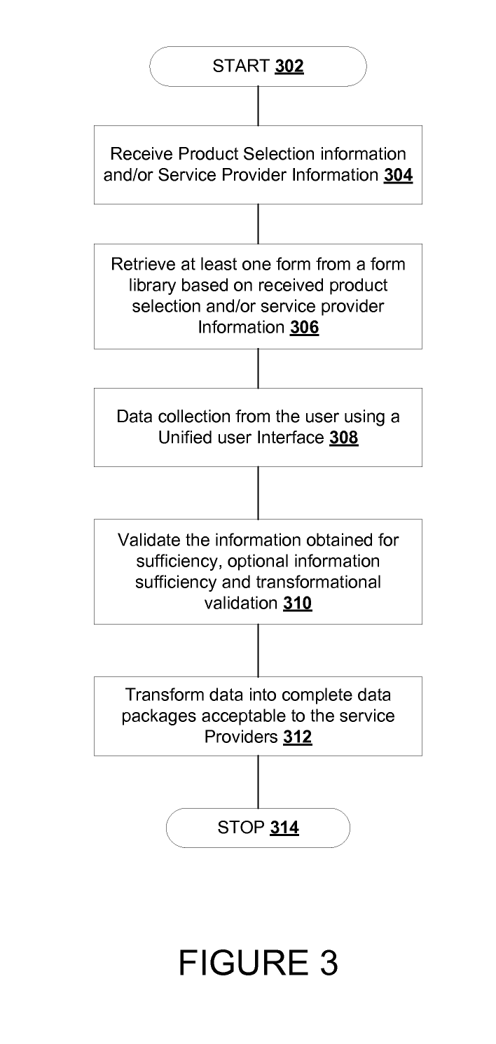

FIG. 3 is a flowchart of an exemplary process in accordance with one or more embodiments of systems and methods for uniform compliant integrated workflow. Process 300 begins at 302.

Processing continues to 304, where product selection information is received from a customer 260 using a uniform user interface 200 from at least one computer terminal. In one or more embodiments, the product selection may include business type, e.g. broker dealer, unaffiliated, registered investment advisor, benefits consulting, diversity funds and insurance; product type; service provider; financial instrument. In one or more embodiments, the product type could be multiple levels where an initial type from a first list is chosen and then a second product type is chosen from a second list. For example, the first selection may be a product selection to a broker dealer at step 304. The second selection may be a service provider or custodian such as a mutual fund or insurance service provider. The third selection may a financial instrument which include but is not limited to a selection such as 401(k)—Roth, 401(k)—Solo k, 401k, 403b, 457, 529 plan, Administration, banking, charitable giving, charitable remainder trust, trust—under agreement and a trust under will.

Once the product information is received processing continues to 306, where the document transformation layer 220 described hereinabove retrieves at least one form from a form library. In one or more embodiments of the invention the form retrieved may also have associated form validation information.

Processing continues to 308, where data for the selected form is filled in using a uniform user interface 200 as described hereinabove. The data may be populated into the selected form or may modify pre-existing information in the form.

Processing continues to step 310, where the information may be validated for sufficiency, optional information sufficiency and transformational validation at this stage of processing. The validation of information is based on the logic in the business analyst metadata layer 202 and is performed by the document transformation layer 220.

Processing continues to step 312, where the data is transformed into document packages 224 which are acceptable to the service providers 242 and transferred to the service providers 242. In one or more embodiments there may be multiple service providers 242. The requirements may vary according to different service providers, e.g. 242a or 242b, as detailed hereinabove.

Processing continues to step 318, where process 300 terminates.

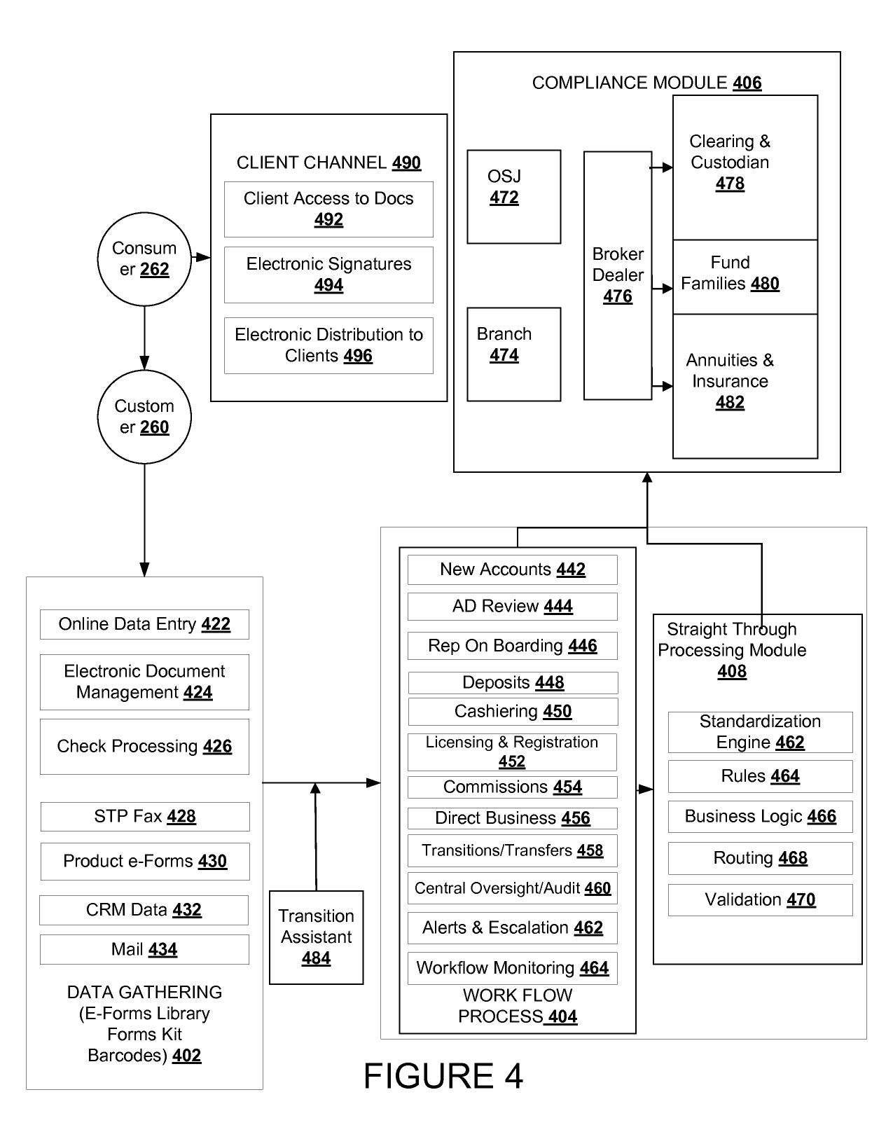

FIG. 4 illustrates a High level overview of the Uniform integrated workflow system which comprises of data gathering, workflow processes, straight through processing, and financial compliance.

Uniform integrated workflow system comprise of a data gathering module 402 configured to capture information entered by a customer 260. The data gathering module then interfaces with the workflow process 404 which interfaces with the Compliance module 406. The workflow process 402 may also interface with the straight through processing system 408 which in turn may interface with the compliance module 406. For example, the compliance module 406 may have suitable processes for the Securities and Exchange Commission regulation and the Financial Regulatory authority.

The data gathering module 402 may have an e-forms library, forms kit and bar code processing. The data gathering module 402 may allow client online data entry 422, Electronic Document Management 424, Check processing 426 (e.g. Check 21 Processing), STOP Fax 428, Product e-Forms 430, CRM Data 432, Mail 434 or any other data relevant or required or supplemental to the process 436.

The workflow process module 404 may have workflows for new accounts 442, AD review 444, Rep on Boarding 446, Deposits 448, Cashiering 450, Licensing & Registration 452, Commissions 454, Direct Business 456, Transitions/Transfers 458, Central Oversight/Audit 460, Alerts and Escalation 462 and Workflow Monitoring 464. The workflow process may interface directly with the compliance module 406 or interface with the compliance module 406 through the straight through processing system 408.

The straight through processing system 408 may contain Standardization engine 462, Rules 464, Business Logic 466, Routing 468, Validations 470. The straight through processing system 408 may be located either locally or on a server in the client premises, hosted on a cloud computing service, hosted at the service provider 242 locations or hosted by a neutral third-party. The neutral third party may operate at arms-length from both the service provider 242 and the customer 260. This enables the neutral third party to provide transition services using a transition assistant 484 where there is effective separation of the processing between the customer 260 who may have multiple service providers, e.g. 242a and 242b, and exposure to different business methods including but not limited to actuarial tables, standard business practices of a service provider, e.g. 242a, which are proprietary and incompatible or unauthorized for use with any other service provider 242 or such access is not permitted by financial regulations. Similarly, the service providers 242 can be effectively protected by ensuring compliance with financial regulations such as audits, oversight using a uniform data model. This leads to better compliance and reduction of paperwork and costs for the service providers.

The Standardization engine 462 enables abstraction of the different form fields by mapping the different form fields of different forms of different products for the same service provider, different forms of the same product of different service providers, e.g. 242a and 242b, different forms of different products of different service providers based on the data required in the form fields. For example, all forms may require a First Name and a Last Name field. The standardization engine uses these inputs which are common to forms to abstract the forms enabling a uniform user interface to be presented to the customer 260. The standardization engine relies on Rules 464 and Business Logic 466 to analyze the different forms of service providers 242 and to update details when the forms change. The Standardization engine 462 enables the customer 260 to focus on the data and abstracts the customer 260 from focusing on the differences in layout of the forms and peculiarities of implementation of the forms in different products by a service provider, e.g. 242a, or as the case maybe different service providers, e.g. 242a and 242b.

The rules 464 and business logic 466 may include the financial regulations governing the transaction, best practices of the organization, best practices of a particular service provider, e.g. 242a, the service provider, e.g. 242a, mandates which are separate and distinct from the financial regulations which may be over and above the requirements laid out by the financial regulations, rules laid out by the office of supervisory jurisdiction, rules which dictate which of the forms go together, rules which dictate which forms fields are mandatory for a particular transaction, form fields which are considered mandatory by a particular service provider, e.g. 242b, forms fields which are considered supplemental to the transaction but are necessary, the instances where data in addition to the form fields is necessary such as checks, payment information, personal identification information etc.

In one or more embodiments the straight through processing system 408 may be part of the workflow process module 404. In one or more embodiments the rules 464 and business logic 466 and the straight through processing module 408 may be used in various stages of the processing hierarchy. For example, as set forth above during the data gathering some forms of validation may be performed upfront and this may involve the workflow process module 404. In one or more embodiments the validations are pervasive and may occur at any point in the entire workflow to ensure compliance with the requirements of the service providers 242 and the financial regulation. These changes can be controlled by modifying the rules 464 or business logic 466. In one or more embodiments the business logic 466 and rules 464 may be interchangeable and may contain similar information or implemented without a distinction between the rules 464 and business logic 466.

Compliance Module 406 may consist of Office of Supervisory Jurisdiction 472, the branch 474, the broker dealer 476, Custodian and clearing house 478, fund families 480 and the Annuities & Insurance 482. The Office of Supervisory Jurisdiction 472 is a main or branch office of a member where at least one or more of the following takes place: order execution, market making, public offering structuring, private placement structuring, customers funds or securities vault, approval of new accounts, customer order review and endorsement, approval of advertising or sales literature of approved associates and supervision of activities of associated persons at other branch offices. The Office of Supervisory Jurisdiction 472 may interact with the branch 474 and supervise its activities and approve or endorse all the transactions which may require mandatory supervision or are required for internal standards and maintenance or to meet other requirements of the service provider 242. The Office of Supervisory Jurisdiction 472 may interface with the broker dealer 476 to place the orders with the market which may be Funds, stocks, annuities & insurance or may deal with the clearing and custodian 478, fund families 480 and Clearing and Custodian 478.

The client channel 490 may be used by the customer 260 to enable direct client transactions by client 488 including but not limited to client access to documents 492, Electronic Signatures 494 and Distribution to Clients 496.

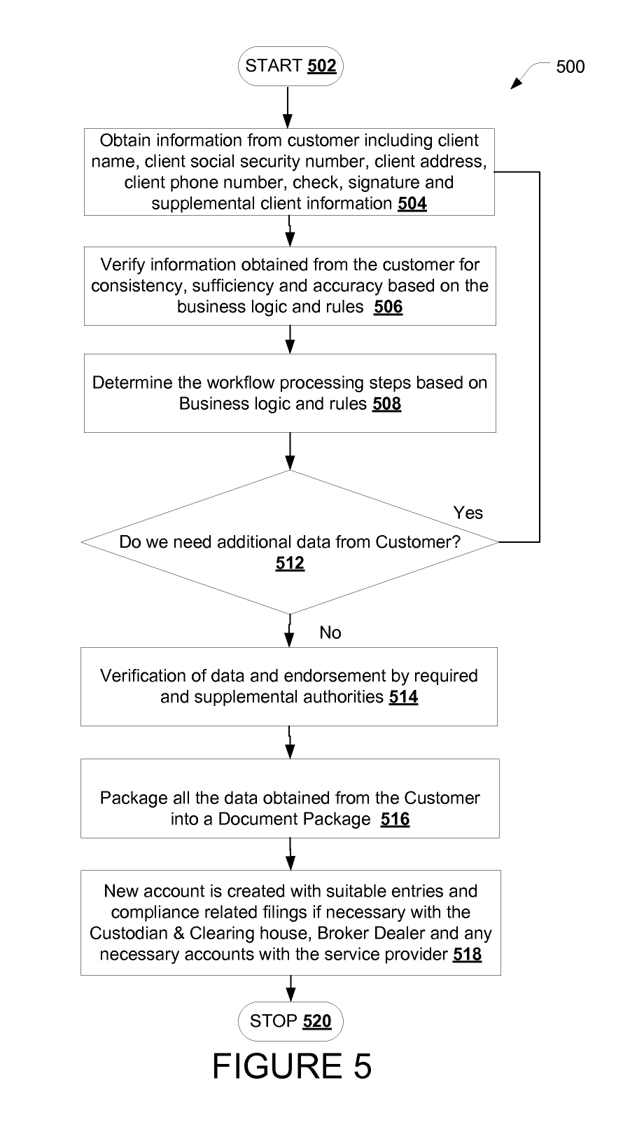

FIG. 5 illustrates a flowchart of an example workflow process. The workflow process illustrates one or more embodiments of a new accounts process using the uniform integrated workflow system which details the new account process. Process 500 begins at step 502.

Processing continues to step 504 where information is obtained from the customer 260 using a uniform user interface 200 from at least one computer terminal. The information obtained from customer may include information about the client name, client social security number, client address, client phone number, client signature, supplemental client information, payment details and check details.

Once the information from the customer 260 is received processing continues to 506 where the information obtained from the customer is processed through a validation process based on the rules and business logic as set forth herein above.

Once the information from the customer 260 is validated processing continues to 508 where the information obtained from the customer is processed to determine the workflow processing steps based on business logic and rules. For example, there may be different workflow processing steps for a new account for annuity insurance as opposed to an investment portfolio. This difference in processing is handled seamlessly as far as the consumer 260 is concerned as he is provided with a uniform interface irrespective on the internal processing steps.

Once the workflow processing steps are determined based on business logic and rules the processing moves to 512 where a determination is made on the sufficiency of information for all the workflow processing steps is established and the workflow processing may move back to step 504 to obtain any additional information. In one or more embodiments 512 and 508 may be performed concurrently with 504 and 506 based on the implementation requirements and complexity. For example, if additional inputs are required from a service provider 242, broker dealer or branch there may be an implementation with multiple validations at both 504, 506 and at 512.

Once all the required information is obtained from the customer processing moves to 512. The data obtained from the customer 260 may be verified by the office of supplementary jurisdiction and the broker dealer to ensure compliance with the financial regulation and standards of the organization.

The processing moves to 516 where all the data obtained from the customer 260 along with all the additional information required for the new account transaction such as scans of identification documents, verified payment information such as checks, transaction id, routing number, details of additional products or specifications from the customer 260 are packaged into a format consistent with the requirements of the specific service provider, e.g. 242a, called a Document Package 224. The document package may then be transmitted to the service provider 242 as set forth hereinabove.

Once the document has been packaged the processing moves to 518 where a new account is created with the information obtained from the document package 224. The processing moves to 520 where it ends.

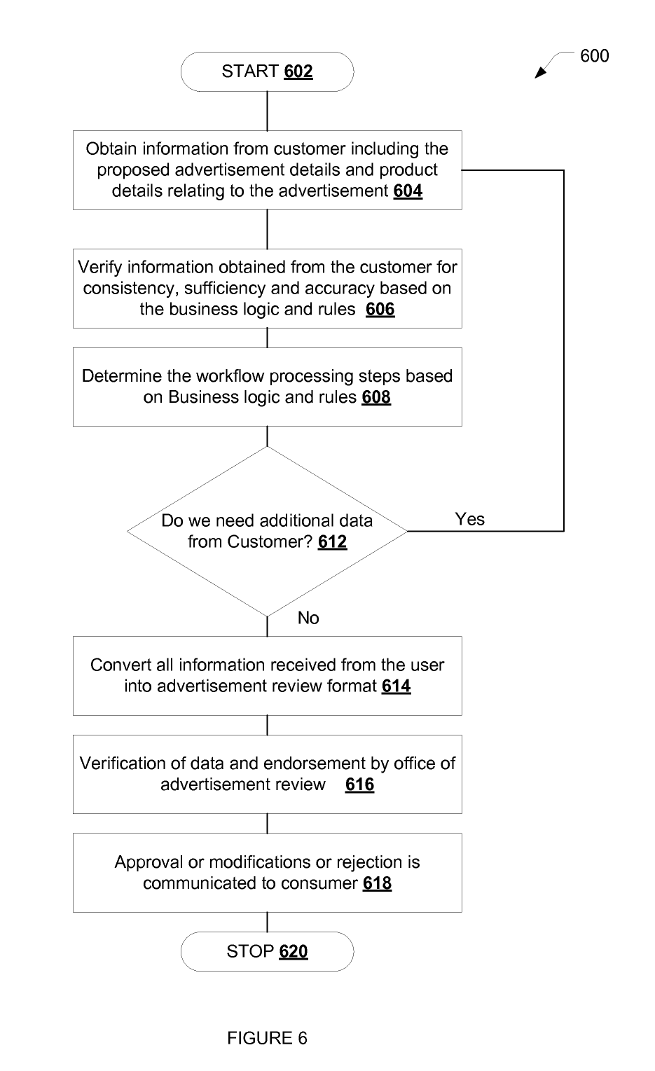

FIG. 6 is a flowchart of an exemplary process in accordance with one or more embodiments which details the advertisement review workflow process. Process 600 begins at Step 602.

Processing continues to 606 where the information from the customer including proposed advertisement details and product details relating to the advertisement are verified for consistency, sufficiency and accuracy based on business logic and rules.

Processing continues to 608 where the workflow steps are determined based on business logic and rules. For example, certain service providers, e.g. 242a, may require advertisements to be vetted not just by the advertisement review board but also by their legal teams if the volume or scope of the transaction exceeds certain preset limits. Similar changes to this process as laid out for process 600 apply in this case for multiple validations or lack thereof as set forth hereinabove.

Processing then continues to 612 where a determination is made on any additional data that may be required from the customer. If additional data is required the information is obtained by moving back to 504. If no additional information is required the processing moves to 614. The information received from the customer is converted into a format suitable for processing such as a document package 224 or any other format for this process and is passed onto the service provider 242.

Processing then continues to 616 where the data is verified and endorsed by office of administrative review. This process may vary based on the financial regulations and policies of the service provider 242.

Once the decision on the advertising has been reached processing proceeds to 618 where the customer is apprised of the decision and any required modifications. The decision could be an approval, rejection or an approval subject to modification of certain content.

Processing moves to 620 where it ends.

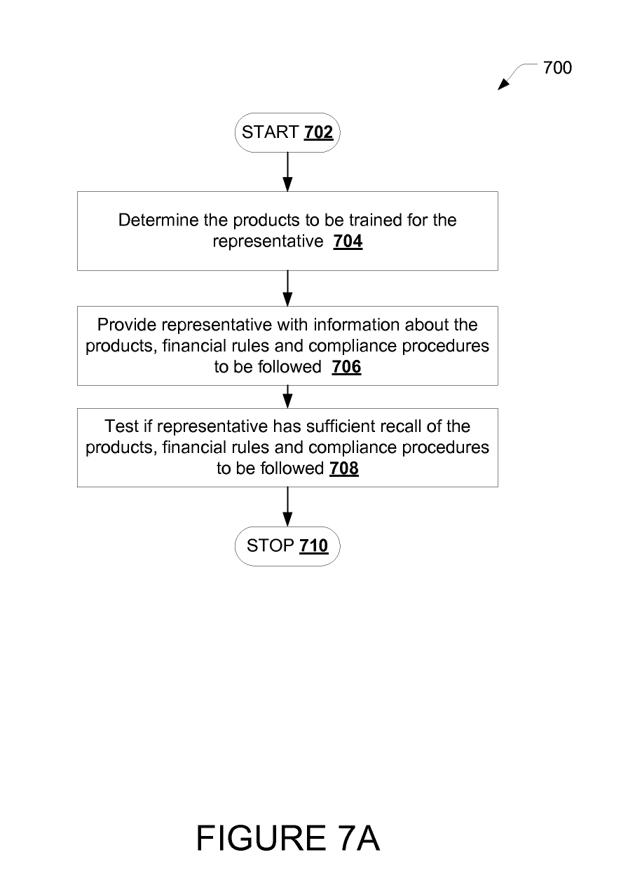

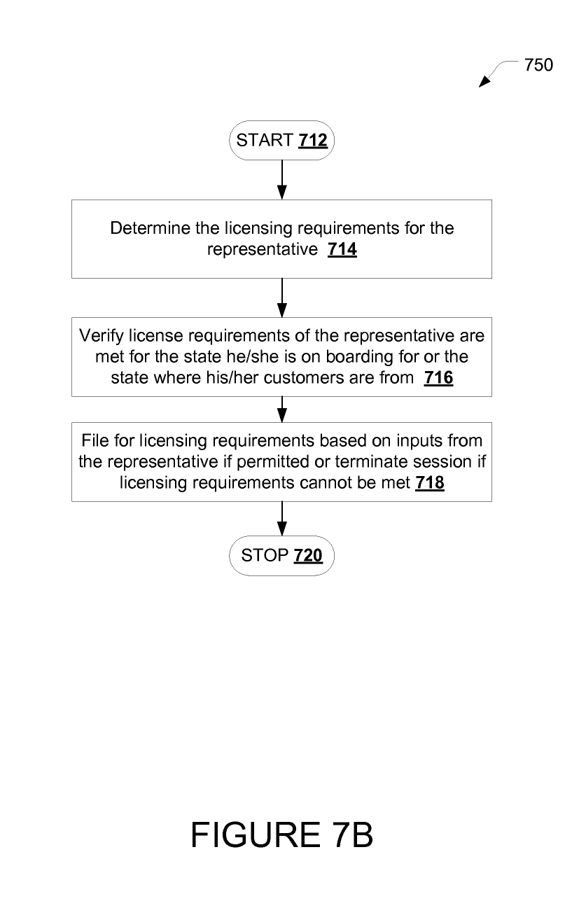

FIG. 7A is a flowchart of an exemplary process in accordance with one or more embodiments of the systems and methods of the invention dealing with Representative on-Boarding. Process 700 beings at step 702.

Processing continues to 704, where the representative of a customer selects a list of products to be trained on for a service provider e.g. 242a. The representative of a customer can receive training on the financial regulations, compliance requirements, any compliance or internal procedures of the service provider using the representative on boarding process.

The process then moves to 706 where the representative is provided with information about a service provider 242 and financial regulations and compliance procedures followed by the service provider e.g. 242a.

The process then moves to 708 where the representative may be tested on the information which was presented to the representative during the on boarding session to test if the representative has absorbed sufficient information or the effectiveness of the training session by measuring the information absorbed presented during the session.

The process then moves to 710 where it ends.

The process listed in 700 may include additional workflow processes for licensing and registration. This additional workflow processes is illustrated in process 750. This process may be used in both representative on-boarding and in verification of licensing requirements in other workflow processes such as new account creation.

FIG. 7B is a flowchart of an exemplary process in accordance with one or more embodiments of the systems and methods of the invention dealing with licensing and registration. The process begins at 712 and moves to 714 where a determination is made about the licensing requirements of a selected product and additional information such as the location entered by customer 260. Processing then proceeds to 716 where a determination is made as to whether the representative meets the licensing requirements. If there is any deficiency in licensing these deficiencies may be rectified by filing appropriate paperwork with the state or there may be some additional tests or licensing which the representative requires before he can continue with the representation.

Processing then proceeds to step 718 where appropriate filings may be made based on inputs from the representative. In the event of a new account opening if a representative is not licensed in a state and this cannot be fixed by information available from a representative. The workflow may be terminated to ensure compliance with the financial reporting requirements.

Processing proceeds to 720 where it ends.

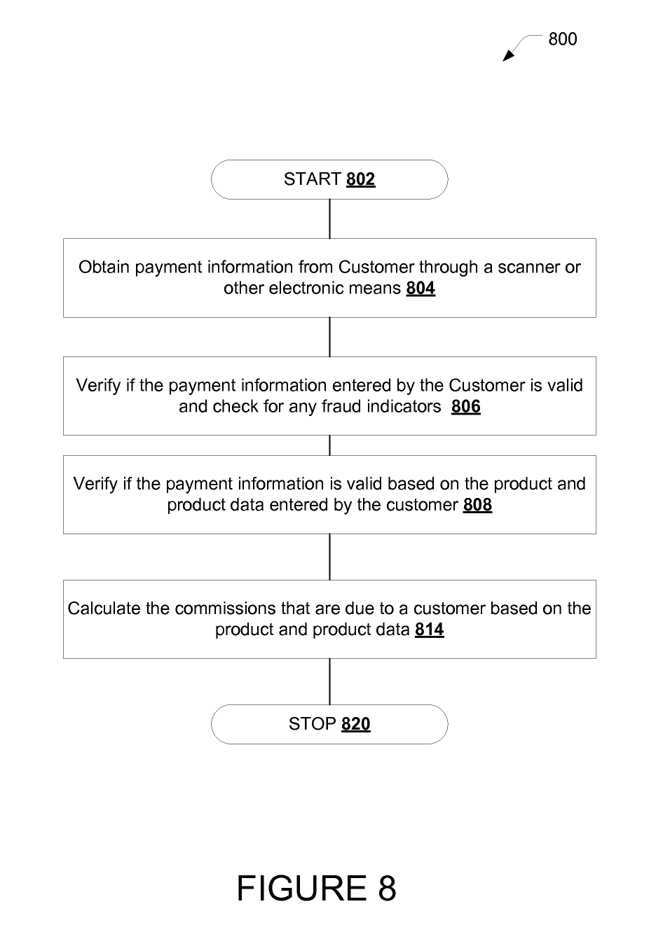

FIG. 8 is a flowchart of an exemplary process in accordance with one or more embodiments of systems and methods for compliant integrated workflow which deals with the workflow process for Deposits, Cashiering and Commissions. Process 800 begins at step 802.

Processing continues to 804, where payment information is obtained from the customer through a scanner or other electronic means. The customer may be required to provide electronic signatures. The customer is provided with a consistent user interface regardless of the physical hardware used such as the scanner and the product information. The process then proceeds to 806.

The information provided by the customer may be verified for consistency and indications of fraud at 806. This fraud indication may be based on the information provided by the customer 260 such as routing number, first name, last name, social security number, and address, date of birth and signature requirements. This service may be provided by a third party and integrated into the service. In one or more embodiments of this invention fraud processing such as check fraud processing may be carried out using check 21 processing.

The processing then continues to 808 where the payment information is verified for validity based on the product selection. For example, a product may require a minimum investment or a pre-determined investment or initial charges or pre-determined recurring charges such as annuities or a monthly premium. This information is verified and if this information does no match the customer 260 may be alerted to the problem.

The processing then continues to 814 where the commissions that are due to customer 260 are calculated. The commissions that are due at step 814 may be a one-time commission in the new account process or a recurring commission which is made available to customer 260 based every time a consumer makes a premium payment. This calculation and information storage is simplified and the customer 260 has a single user interface to deal with in trying to get this information.

The process then moves to step 820 where it ends.

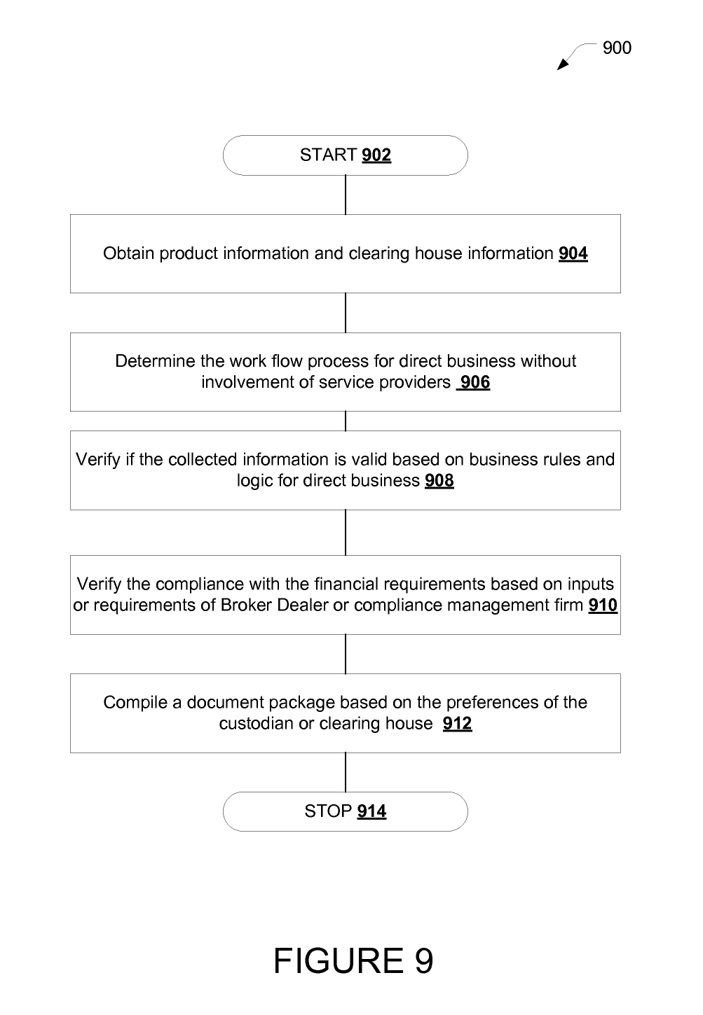

FIG. 9 is a flowchart of an exemplary process in accordance with one or more embodiments of systems and methods for uniform compliant integrated workflow and the workflow process for direct business transactions. Process 900 begins at 902.

Processing continues to 904, where the information about a product is obtained from the customer 260 through one or more interface terminals at the premises of the customer 260. Some customers 260 in the financial system may choose to provide financial services independently of the branches and office of supervisory jurisdiction. They may instead look to the broker dealer 476 or such similar entity for compliance with the financial regulations and deal directly with clearing & custodian houses 478 and fund families 480 and annuities and insurance companies 482.

Processing continues to 906, where the data gathered is processed through work process which is specially curated for direct business without the involvement of service providers 242. These processes may or may not include broker dealers 476 and the may interface directly with the clearing & custodians 478, fund families 480 and annuities and insurance 482.

Processing continues to 910, where the data gathered is processed through financial compliance and requirements based on inputs or requirements of the broker dealer or compliance management firm.

Processing continues to 912, where the data gathered is compiled into a data package based on the preferences of the custodian or clearing house and sent to the custodian or clearing house in the preferred format. This might include payment instructions or other information which is necessary for processing the package such as customer 260 details, signature, and compliance details if there is no third party compliance provider.

The processing then continues to 914 where it ends.

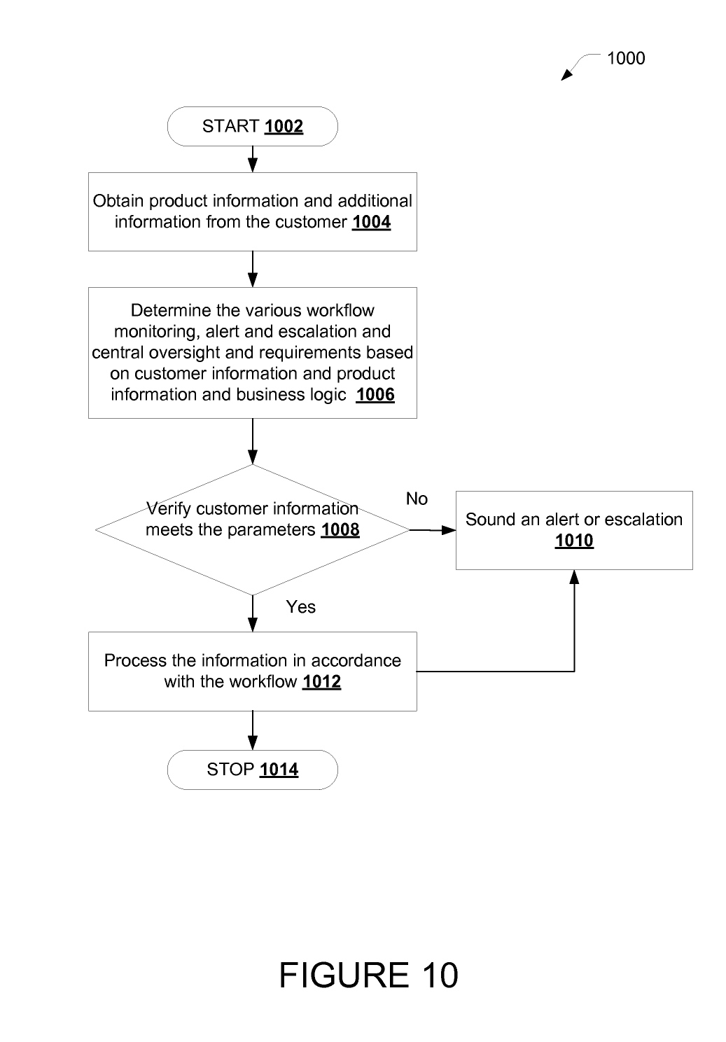

FIG. 10 is a flowchart of an exemplary process in accordance with one or more embodiments of system and methods for uniform compliant integrated workflow for central oversight and audit, alerts and escalation and workflow monitoring. Process 1000 begins at 1002.

Processing continues to 1004 where the product information and information required are obtained from the customer 260. The processing then proceeds to 1006.

The information provided by customer 260 is analyzed at step 1006 to determine the parameters of the workflow monitoring, alert and escalation information, central oversight and audit requirements. These parameters may be obtained from the business logic and the rules. The processing then moves to 1008.

The customer information is verified at 1008 to determine if it meets the parameters set out by the service provider 242. The service provider 242 may require alerts based on the severity or frequency of violations of the rules. They may also require escalations when these parameters are not met or an issue is not resolved with a stated time period.

The processing proceeds to 1010 if there is a parameter that is not met. Based on the parameter that is not met an alert may be sent to the service provider 242. In one or more embodiments an escalation to a different level within the service provider 242 may be made.

If data meets the parameters determined as set forth in 1006 hereinabove based on the business logic and rules the processing proceeds to 1012 where the information is processed in accordance with one or more workflow processes which are listed above or any other workflow process that may be defined by the business analyst.

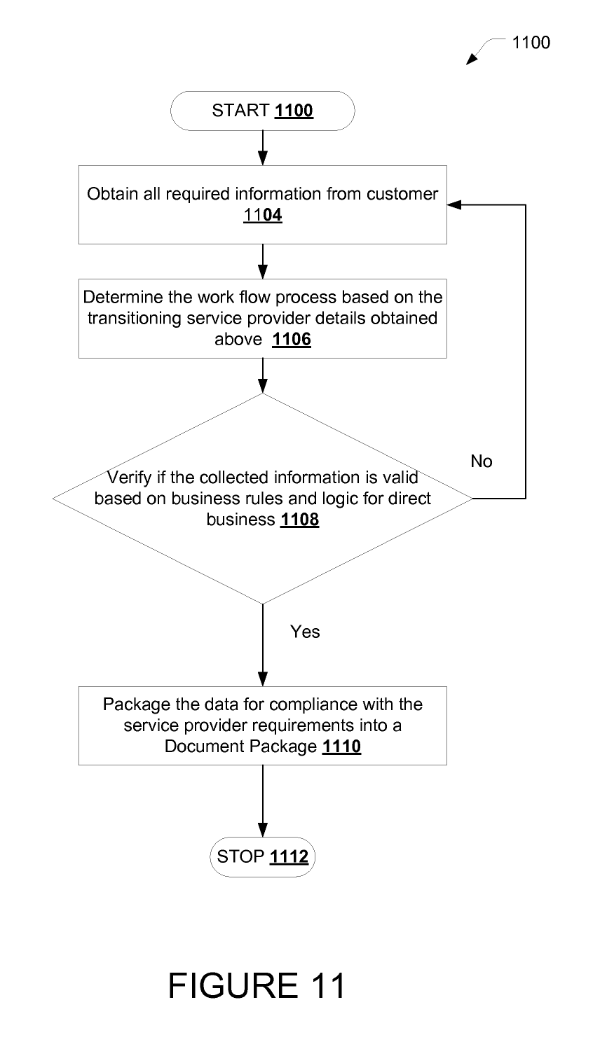

FIG. 11 is a flowchart of an exemplary process in accordance with one or more embodiments of systems and methods for uniform compliant integrated workflow and the transfer/transition workflow. Process 1100 begins at 1102.

Processing continues to 1104, where all required information is obtained from the customer 260. The information is obtained using a uniform user interface. This is an important attribute during the transition or transfer process. The customer 260 may not have been on boarded with the new service provider 242 and may not do so until he has complied with all the requirements of the financial regulations. The straight through processing system acts as a middle man here.

Processing continues to 1106, where the information acquired above is processed to determine the workflow. The workflow may vary according to the service provider 242 to which the customer 260 is transitioning. The customer 260 may not be aware of the requirements of the new service provider 242 and the business logic and rules of the service provider 242 are handled seamlessly by the straight through processing network.

The workflow proceeds to 1108 where a validation of the information obtained is made to ensure there is sufficient information for transitioning between the service providers 242. If the information is not sufficient the information is obtained from the customer 260 at 1104. If sufficient information is available the processing moves to 1110 where the data is packaged into a document package suitable for the service provider 242. The data is transmitted to the service provider 242

Processing then proceeds to 914 where the process stops.

All the processes descried herein above are exemplary workflow processes. A business analysis can use meta-language to easily create new workflow processes or modify existing workflow processes as required by the financial regulations or as and when the forms are updated by the service provider 242. These exist merely as exemplary workflow processes and they may be performed in a different order or may be combined to create a completely different workflow process based on the business requirements.

The invention herein has been disclosed and described with reference to financial service providers and insurance processing. The service provider as described in this invention may be extended to any business which involves processing of documents and/or has a service component with workflows. For example, a service provider may be a doctor and the customer may be a patient of the doctor. Further examples may include lawyers and clients; accountant and clients; and tax consultants and clients.

While the invention herein disclosed has been described by means of specific embodiments and applications thereof, numerous modifications and variations could be made thereto by those skilled in the art without departing from the scope of the invention set forth in the claims.

What is claimed is:

1. A computer-readable non-transitory medium comprising computer-readable instructions for uniform compliant integrated workflow, wherein execution of said computer-readable instructions by one or more processors causes said one or more processors to carry out steps comprising:
receiving product selection information from a customer through a user interface from a computer terminal;
selecting at least one form from a form provider library based on the product selection information, wherein said form provider library comprises forms from at least one service provider;
receiving data for the at least one form from the customer through the user interface, where the data is at least one of form data, signature data, output from signature pads and scanned document;
validating said data received from the customer based on at least one criteria, wherein the criteria is at least one of a business logic, form sufficiency information, optional information sufficiency, transformational validation, electronic signature verification, physical signature capture, transformational validation and document scanning; and
transforming the data into document package consistent with a low level application programming interface used for interconnection with a service provider.

2. The computer-readable non-transitory medium of claim 1, wherein the criteria comprises a rule set consistent across different service providers.

3. The computer-readable non-transitory medium of claim 1, wherein the user interface remains unchanged irrespective of service provider.

4. The computer-readable non-transitory medium of claim 1, wherein the document package includes at least one of data, form and scanned image document.

5. The computer-readable non-transitory medium of claim 1, wherein the provider is at least one of a bank, clearing house, insurance company, mutual fund, tax preparation firm, doctor and insurance carrier.

6. The computer-readable non-transitory medium of claim 1, wherein the transformation is at least one of, form processing and electronic signature verification.

7. The computer-readable non-transitory medium of claim 1, additionally receiving data from the customer about at least one additional service provider from a customer for transitioning from one service provider to a second service provider and transforming the data into a second document package consistent with a low level application programming interface used for interconnection with the additional service provider.

8. A method for uniform compliant integrated workflow comprising:
receiving product selection information from a customer through a user interface from a computer terminal;
selecting at least one form from a form provider library based on the product selection information, wherein said form provider library comprises forms from at least one service provider;
receiving data for the at least one form from the customer through the user interface, where the data is at least one of form data, signature data, output from signature pads and scanned document;
validating said data received from the customer based on at least one criteria, wherein the criteria is at least one of a business logic, form sufficiency information, optional information sufficiency, transformational validation, electronic signature verification, physical signature capture, transformational validation and document scanning; and
transforming the data into document package consistent with a low level application programming interface used for interconnection with a service provider.

9. The method of claim 8, wherein the criteria comprises a rule set consistent across different service providers.

10. The method of claim 8, wherein the user interface remains unchanged irrespective of service provider.

11. The method of claim 8, wherein the document package includes at least one of data, form and scanned image document.

12. The method of claim 8, wherein the provider is at least one of a bank, clearing house, insurance company, mutual fund, tax preparation firm, doctor and insurance carrier.

13. The method of claim 8, wherein the transformation is at least one of form processing and electronic signature verification.

14. The method of claim 8, wherein the scanned document is a check and the transformation is at least one of check processing and check fraud detection.

15. The method of claim 8, wherein an additional step is receiving data from the customer about at least one additional service provider from a customer for transitioning from one service provider to a second service provider and transforming the data into a second document package consistent with a low level application programming interface used for interconnection with the additional service provider.

16. A system comprising:
a server;
a server module in said server configured for document processing;
a client terminal coupled to said computer and configured to display a user interface for receiving or transmitting information from or to a customer;
a document transformation layer module configured to connect said user interface module to said client terminal to receive or transmit information to the user interface module, consisting of at least one form library module configured to provide at least one form based on a product selection by a customer using the said user interface, at least one form processing engine configured to process the said form and perform validations based on information stored in a business analyst metadata layer, a low level API transformation module configured to transform the information received from the said customer into a document package acceptable to at least one service provider; and
an interconnect interface which links the document transformation layer to at least one service provider and configured for transferring of the said document package to the service provider.

17. A system of claim 16, wherein the said document transformation layer further comprises a check processing module for processing checks.

18. A system of claim 16, wherein the said document transformation layer further comprises a check fraud module for detecting fraudulent checks.

19. A system of claim 16, wherein the said document transformation layer further comprises a document management module for the forms and the data provided by the customer.

20. A system of claim 16, wherein the said low level API transformation module produces document packages for a second service provider during a transition process.
